(19) United States
(12) Patent Application Publication
(10) Pub. No.: US 2009/0075579 A1
(43) Pub. Date: Mar. 19, 2009

(54) CUTTING APPARATUS

(75) Inventors: Henrik Boss, Gudhjem (DK); Mikael Krogh, Skodstrup (DK); Gorm Sorensen, Aakirkeby (DK); Ole Schou Mortensen, Ronne (DK)

Correspondence Address: PEARNE & GORDON LLP, 1801 EAST 9TH STREET, SUITE 1200, CLEVELAND, OH, 44114-3108, US

(73) Assignee: Scanvaegt International A/S, Arhus N (DK)

(21) Appl. No.: 11/719,184

(22) PCT Filed: Nov. 16, 2005
(86) PCT No.: PCT/DK05/00730

§ 371 Date: Jul. 13, 2007

(30) Foreign Application Priority Data
Nov. 16, 2004 (DK) PA 2004 01776
Jul. 13, 2005 (DK) PA 2005 01027

(51) Int. Cl. A22C 17/00; B26D 3/00

(52) U.S. Cl. 452/156; 452/155

(57) ABSTRACT

An apparatus for cutting of material such as a piece of meat from e.g. an animal, poultry, fish etc., said apparatus (10) comprising support means for said material (40), said support means comprising a cavity (18) and cutting means for cutting said piece of material to a predetermined thickness and/or shape. The apparatus (10) further comprises means for applying force to said material towards said cavity (18), and the support means and the cutting means are configured to be relatively displaceable in a reciprocating manner.

### FIELD OF THE INVENTION

The invention relates to an apparatus for cutting of material such as e.g. a piece of meat from e.g. an animal, poultry, fish etc., said apparatus comprising a support element for said material and cutting means for cutting said piece of material to a predetermined thickness and/or shape.

### BACKGROUND OF THE INVENTION

For certain applications in the food industry it is important that portions of meat have a size that is controllable in regard to weight and thickness. This relates for example to the areas referred to as food-service and/or catering.

The importance of the thickness is reasoned by the fact that the weight is often indicated as a parameter in menus, dining cards etc.

Further, the importance of the thickness is reasoned by consideration to the frying time that must be predictable in order to achieve an optimal taste, while simultaneously health considerations must be observed, e.g. the meat must be heated to a predetermined temperature.

In order to achieve that the weight and thickness of meat portions can be controlled, a number of machines has previously been designed.

For example, WO 00/22934 describes a machine, where objects are fed to the machine and subsequently measured by means of a vision camera. With a horizontal cutting device the objects are afterwards adjusted to the desired thickness. Later on, surplus material can be cut at one end and/or a one side (or possibly both ends/sides) in order to achieve the desired weight. This may for example be done by means of a machine as described in for example U.S. Pat. No. 4,557,019, EP 504,466, U.S. Pat. No. 4,875,254 or U.S. Pat. No. 4,868,951.

However, the interaction between the above-mentioned machines is very complicated and in practice it will not be possible to achieve a satisfactory result.

Another type of prior art machine, by means of which the constraints regarding weight and thickness have been sought to be fulfilled in one work process, is for example described in U.S. Pat. No. 6,383,068. In this type of machinery the pieces of meat that are delivered to the machine, are pressed or sucked into a form with the desired shape and subsequently the surplus material is cut off. This prior art apparatus comprises a plurality of carrier plates each having a cavity, where said carrier plates are transported in an elongated loop. The cutting of the pieces of meat takes place in the upper run of the loop as the carrier plates pass a band saw and as a roller presses the pieces of meat into the cavities. After the cutting the carriers are transported further on and when the carriers enter the lower run of the transport loop, i.e. when they are turned downwards, a grasping mechanism releases the pieces of meat with the desired shape from the cavity.

A similar type of prior art is described in WO 03/079801.

The process according to the prior art of U.S. Pat. No. 6,383,068 and WO 03/079801 relieves the above-mentioned problem relating to the interaction between a number of machines. However, another problem is related to this prior art, namely that it is difficult to change from one size to another since the plurality of forms must be detached and other forms must be installed in the apparatus instead, which can be complicated and time-consuming. Further, a relatively high number of forms or carrier plates must be at hand in different sizes, if it is desired to be able to change to other sizes.

Further, the band saw or knife used for cutting the meat according to this prior art has to pass between the carrier plate and the roller that forces the meat downwards. Thus, the horizontal position of the blade is vital in order to ensure that the size, i.e. thickness of the meat fulfils the requirements and in order to avoid wear caused for example by contact to the carrier plate or the roller.

Thus, it is an object of the present invention to present an apparatus, by means of which material and in particular food items such as meat, e.g. meat of chicken, fish and other animals can be cut into portions that fulfil predetermined requirements in regard to size, and which alleviates the above-mentioned problems related to the prior art.

In particular, it is an object of the invention to provide such an apparatus, which is flexible in use and which allows an easy change of forms to be performed.

Further, it is an object of the invention to provide such an apparatus, which provides food items that fulfil the requirements as regard the size with a high degree of precision.

These and other objects are achieved by the invention.

### SUMMARY OF THE INVENTION

The invention relates to an apparatus for cutting of material such as e.g. a piece of meat from e.g. an animal, poultry, fish etc., said apparatus comprising

support means for said material, and

cutting means for cutting said piece of material to a predetermined thickness and/or shape,

said apparatus further being configured for cutting said piece of material as regards thickness and/or area during a relative displacement between the support means and the cutting means.

According to an advantageous embodiment, as specified in claim 2, said support means may comprise a cavity, the apparatus may further comprise means for applying force to said material towards said cavity, and said support means and said cutting means may be configured to be relatively displaceable in a reciprocating manner.

Hereby it is achieved that such materials may be cut to the desired size using only few form parts, e.g. said cavity in said support, whereby it is relatively easy and uncomplicated to change form size and/or shape, if it is desired or necessary.

Advantageously, as specified in claim 3, said support means may comprise a form plate and an intermediate plate, said form plate comprising said cavity and said intermediate plate comprising an opening, and wherein said cutting means may be configured for passing between the intermediate plate and the form plate.

Hereby, a number of advantages are achieved, including that a precise positioning of the cutting means can be achieved, and that wear on e.g. the form plates caused by contact with the cutting means are reduced or even avoided. Further, the working area of the cutting means are separated from the e.g. pressure means. Still further, it is achieved that if the pieces of material that are loaded on the support means, are connected, for example by meat fibers, skin etc. they will be separated when the cutting means passes under the intermediate plate since the connection between the e.g. two pieces of material is placed on top of the intermediate plate.

According to an advantageous embodiment as specified in claim 4, said support means may comprise at least a support part that is arranged to be pivotal.

Hereby, it is achieved that the pieces of material that has been cut to the desired size can expediently be released, when the pivotal support part is tilted.

According to a further advantageous embodiment as specified in claim 5, said support part that is arranged to be pivotal, may comprise said form plate that is pivotally connected to said intermediate plate.

Hereby, it is achieved that the apparatus may be designed in a particular advantageous manner, allowing the form plate to be connected to the intermediate plate only by e.g. hinge means or the like, and whereby the two parts may be controlled or guided in the reciprocating movements by relatively simple guide means such as e.g. guide means placed at both sides of the two parts.

According to a further embodiment as specified in claim 6, said support means may be configured to reciprocate between a loading position and an off-loading position.

Hereby, it is achieved that an efficient operation can be established where the material can be loaded in e.g. a position, where the support means are located near an operator, and where the cutting operation can be performed when the support means perform a relative movement towards the off-loading position, where the pieces cut to the desired size are released.

Preferably, as specified in claim 7, said cutting means may be adapted for performing a cutting operation while being moved in relation to a said support means being located in a cutting position.

It is apparent that the cutting can be performed with the support means in a fixed position, while the cutting means traverses through the material, vice versa or a combination hereof.

In a preferable embodiment as specified in claim 8, said support means may comprise at least two cavities corresponding to pieces of material to be cut.

Hereby, an effective use of the apparatus is facilitated, e.g. since an operator may advantageously load the apparatus with two pieces of material simultaneously. Further, pieces of material that must be divided into two pieces can also be processed using this embodiment, e.g. by placing a “butterfly” part from a chicken with the two half parts in each of the cavities and with a middle part placed on the part between the two cavities. When the cutting to size is performed, at splitting of the “butterfly” part in two parts is achieved simultaneously, whereby a previous sawing operation is avoided.

According to a still further advantageous embodiment as specified in claim 9, said apparatus may comprise at least two operative parts, each comprising support means and means for applying force to said material towards said cavity.

Hereby, an enhanced efficiency can be achieved, for example since the same cutting means may be used for performing the cutting operation for both (if two operative parts are provided) or all operative parts.

Preferably, as specified in claim 10, said operative parts may be controlled in such a manner that said operative parts are in a loading position alternatively.

Hereby, a further enhanced efficiency can be achieved, for example since one operator may load material into the two (or more operative) parts alternatively, for example by loading one of the operative parts while the other operative part is in the process of cutting the material or off-loading material etc.

Alternatively, as specified in claim 11, said operative parts may be controlled in such a manner that said operative parts are in a loading position essentially simultaneously.

Preferably, as specified in claim 12, said means for applying force to said material towards said cavity may comprise a pressure plate.

According to a further advantageous embodiment as specified in claim 13, said means for applying force to said material towards said cavity may comprise a pressure means comprising a plurality of independently movable fingers or plungers.

Hereby, it is achieved that the material, e.g. the pieces of meat, are pressed into the cavity with a sufficient pressure all over the surface of the cavity in spite of the fact that the pieces of meat that are to be cut, may vary in shape and/or thickness. If a simple pressure plate is used in such instances, it might result in that only part of the material would actually contact the cavity, unless the force was increased, which might on the other hand lead to the undesired effect that the material would be compressed.

Advantageously, as specified in claim 14, said cutting means may comprise a band saw or knife.

According to a further embodiment as specified in claim 15, said support means may comprise a roller or drum.

Hereby it is also achieved that an easy replacement of the form can be performed, for example if it is necessary to change the size of the primary portion.

Alternatively, as specified in claim 16, said support means may comprise a turntable.

According to a still further embodiment, as specified in claim 17, said support means may comprise a conveyor band.

In accordance with an advantageous embodiment as specified in claim 18, said support means may comprise an elevation or a cavity.

According to a further preferable embodiment, as specified in claim 19, said apparatus may comprise means for applying force to said material, which means may comprise a roller or drum.

Hereby pressure means may be provided in an expedient manner.

According to a further advantageous embodiment, as specified in claim 20, said roller or drum may comprise an elevation or a cavity.

Hereby it is achieved that an efficient adaptation of the material, e.g. a piece of meat, to a cavity can be performed, for example by using corresponding elevations and cavities placed on a support and a pressure means, respectively, or vice versa.

Advantageously, as specified in claim 21, said apparatus may comprise means for retaining said material to the support means, said means for retaining said material comprising vacuum means and/or freezing means.

Hereby, the material to be cut can be placed and/or withheld on the support means in an expedient manner. Further, such means, in particular vacuum means, may serve to urge the material into a cavity.

Preferably, as specified in claim 22, said cutting means may comprise reciprocating and/or rotating cutting means that may be controllable as regards e.g. the distance and position in relation to said support means.

Advantageously, as specified in claim 23, said apparatus may comprise scanning, measuring and/or detection means, e.g. in the form of a vision system.

Such means may be particularly advantageous in relation to controllable cutting means in order to achieve a desired optimal result.

According to a still further preferable embodiment, as specified in claim 24, said apparatus may comprise means for lifting, releasing and/or assisting in releasing cut portions from said support means, e.g. in the form of scraper means and/or finger means which may be configured for cooperating with a notch, a groove etc. in said support means.

Hereby, the portions of the material that have been cut may effectively and precisely be released for further processing, packing, etc.

### THE FIGURES

The invention will be explained in further detail below with reference to the figures of which

FIG. 1 shows a cutting apparatus according to a first embodiment of the invention in a schematic side view, showing only the basic elements,

FIGS. 2-8 show in a perspective view a cutting apparatus according to a detailed embodiment of the invention in consecutive steps of the cutting process,

FIGS. 9a-c shows different embodiments of a pressure plate, and

FIGS. 10-14 shows embodiments of a cutting apparatus according to further aspects of the invention.

### DETAILED DESCRIPTION

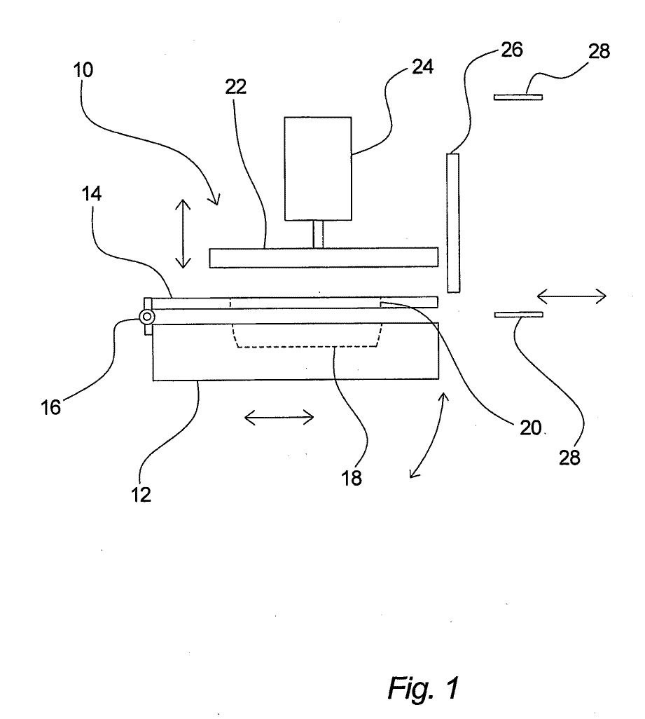

A cutting apparatus according to a first embodiment of the invention is shown in a schematic manner and in a side view in FIG. 1. Only the basic elements are illustrated in FIG. 1 for the sake of clarity.

The apparatus, which is generally designated 10, comprises a form plate 12, above which an intermediate plate 14 is located. These two elements are connected in such a manner that they may pivot relatively, for example by means of a swivel joint, hinge or the like 16 as illustrated. The form plate 12 comprises a form, a cavity or a mould 18 corresponding to a desired shape for the material to be cut, and correspondingly the intermediate plate 14 has an opening 20. Further, the apparatus comprises a pressure plate 22, which is driven by an actuator such as e.g. a pneumatic or hydraulic cylinder 24 or an electric drive motor such as e.g. a linear motor. Also, the apparatus 10 comprises a scraper 26 and means for cutting the material, which means may for example be a band saw or knife 28 as illustrated, e.g. with an upper and a lower run shown in a sectional view.

The form plate 12 and the intermediate plate 14 may as shown by the double-arrow be displaced to the left and to the right. In a position displaced to the left, the material to be cut can be placed on the intermediate plate, whereafter the form plate 12 and the intermediate plate 14 can be shifted to the position shown in FIG. 1. Here, the pressure plate 22 is pressed down towards the material, which will be pressed into the form or mould 18. In a further step, the cutting means, e.g. the band saw 28, is displaced to the left, whereby the lower run of the blade will cut the material between the form plate 12 and the intermediate plate 14. In the next step, the pressure plate 22 is lifted and the form plate 12, the intermediate plate 14 and the band saw 28 are displaced to the right, whereby the material, which has been severed from the material located in the form or mould 18, engages the scraper 26 and slides along the intermediate plate 14 until it slides off the edge of the plate. As it will be further explained below, such material can be used for cutting further pieces with a desired shape or used for other purposes. As the form plate 12 and the intermediate plate 14 is shifted further to the right, the two parts are allowed to pivot in relation to each other, e.g. the intermediate plate 14 is kept essentially horizontal, whereas the form plate 12 is allowed to swivel downwards as illustrated by the double-arrow, whereby the material which has been cut to the desired shape, falls out of the form or mould 18. Next, the form plate 12 and the intermediate plate 14 is moved to the left again, during which movement the form plate is swivelled back to an essentially horizontal position, until these two parts are located as shown in FIG. 1, whereafter the above-described steps can be repeated.

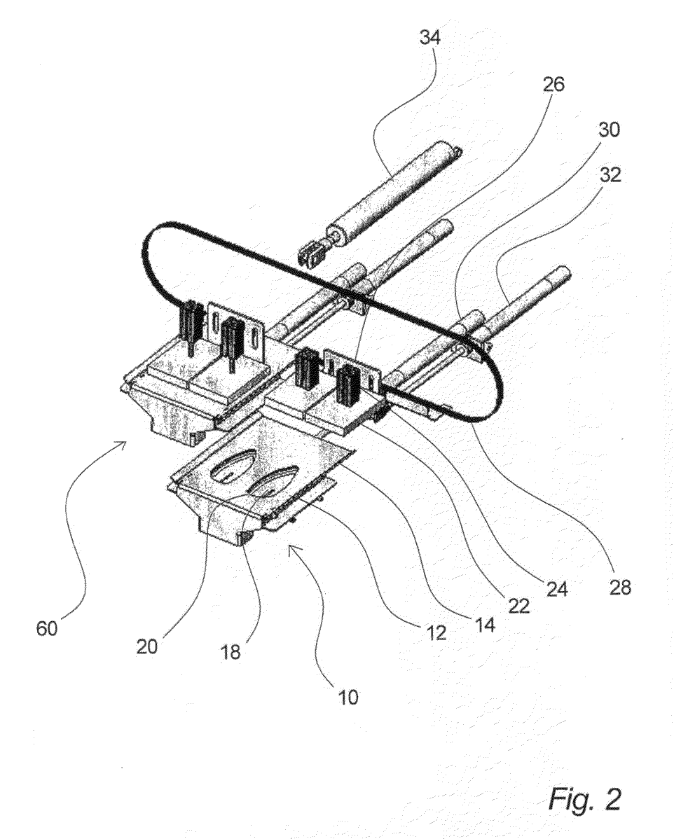

This embodiment of the invention will be further explained with reference to FIGS. 2 to 8, which in a perspective view show a more detailed embodiment of such an apparatus in different steps of the cutting process. The apparatus according to FIGS. 2 to 8 comprises two operative parts 10 and 60, which each comprises a form and intermediate plate for accommodating two items, e.g. a double-form. The two parts 10 and 60 are in principle similar and therefore only one of these, e.g. the part 10, will be dealt with in detail in the following, although reference also will be given to the other.

In FIG. 2 the part 10 is shown with the form plate 12 and the intermediate plate 14 in the loading position, e.g. a position where the material to be cut can be placed on the intermediate plate 14 above the opening 20 in the intermediate plate and the cavity of form 18 in the form plate 12. As it also can be seen in FIG. 2, a number of actuators are arranged for moving the elements of the apparatus in the desired manner. As already described above, the pressure plates 22, of which one or as shown two may be provided for the part 10, are each actuated by means of an actuator 24, e.g. a cylinder or an electric actuator. Further, the connected form plate 12 and the intermediate plate 14 are for example moved by means of two pneumatic or hydraulic cylinders 30 and 32, where the cylinder 30 serves to move the form plate 12 and the intermediate plate 14 between the loading position and the cutting position, while the cylinder 32 serves to move these elements between the cutting position and an off-loading position. Further, the cutting means, which in FIGS. 2-8 is shown as being a band saw or band knife 28, is moved by means of e.g. a pneumatic or hydraulic cylinder 34 between two positions. In the loading position (for the part 10) as shown in FIG. 2, the band saw 28 is in a rearward position.

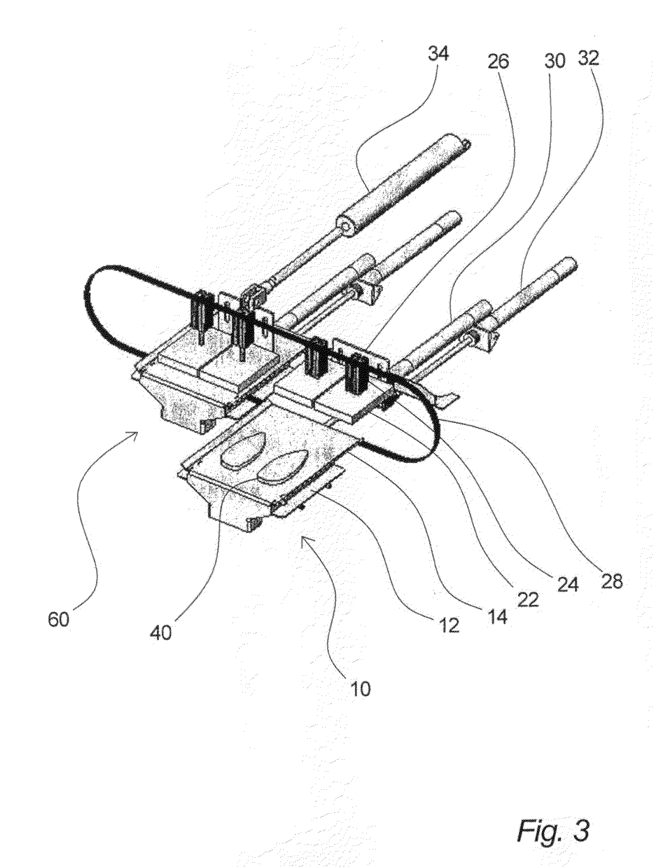

In FIG. 3 it is shown that two items 40, for example two pieces of meat which are to be cut into a desired shape and with a desired thickness, are placed on the intermediate plate 14. Further, it is noted that the band saw 28 has been moved forward, while cutting the items that are placed in the other part 60.

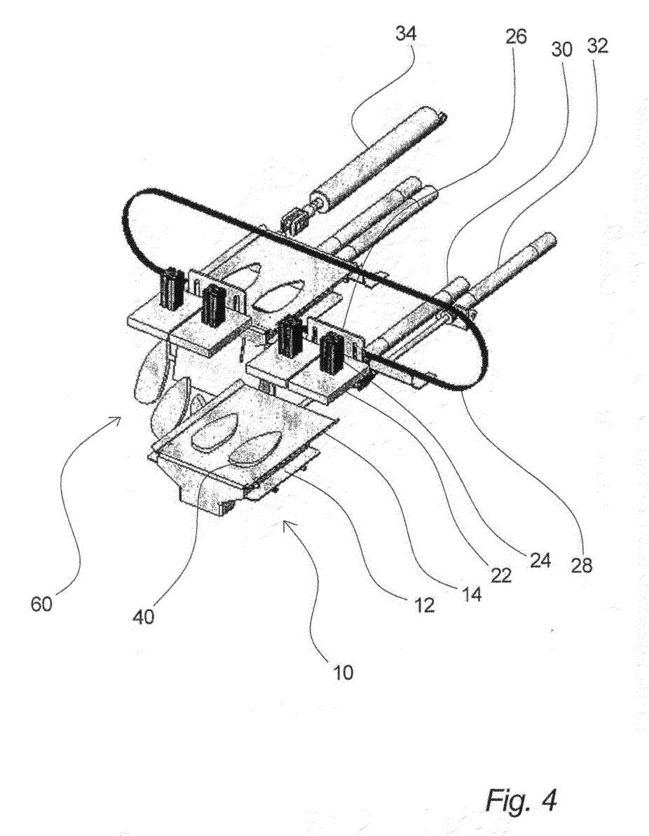

In FIG. 4 it is shown that the band saw 28 has been moved backwards again and that the portions resulting from the cutting operation are being off-loaded from the part 60. This, however, will be explained in detail later on for the part 10.

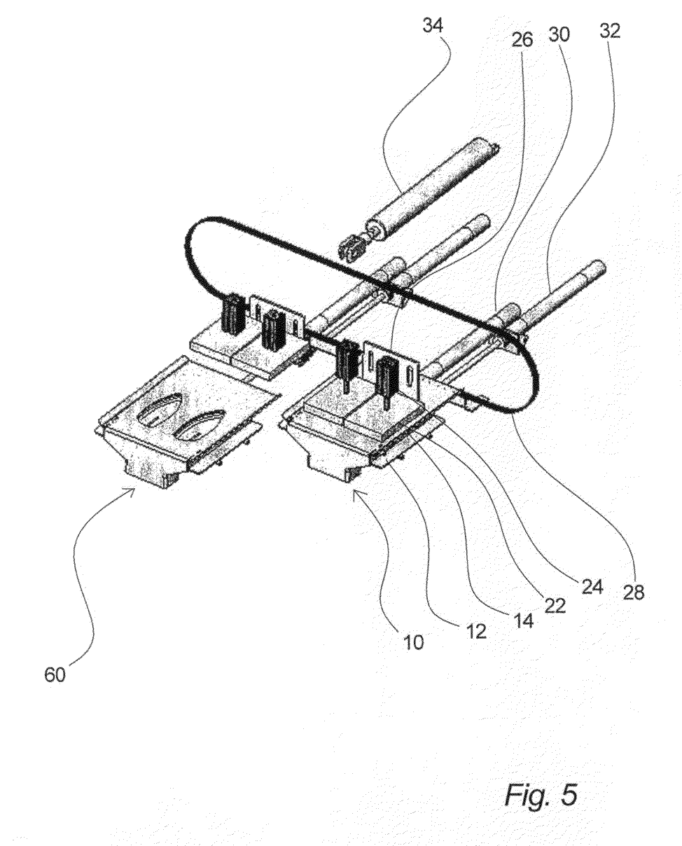

In FIG. 5 it is shown that the form plate 12 and the intermediate plate 14 has been moved to the cutting position, e.g. by means of the cylinder 30, where the pressure plates 22 has been moved downwards, pressing the items down into the form or cavity 18, cf FIG. 1. It will be understood that a force sufficient to make the material effectively take the shape of the cavity of form 18 will be used, e.g. provided by the actuator(s) 24. It is noted that the other part 60 now is in a loading position.

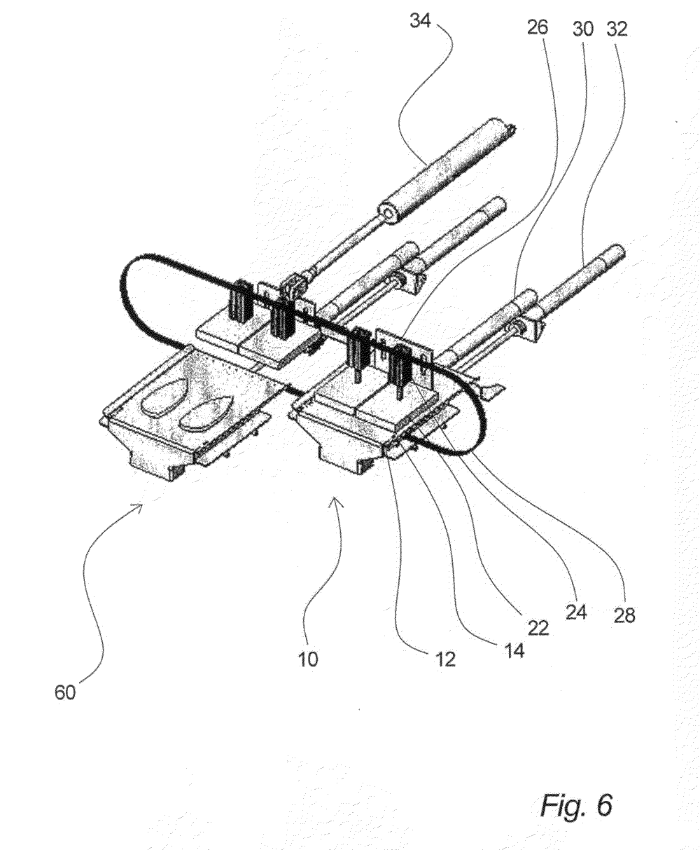

As shown in FIG. 6, the band saw 28 is now moved forward by means of the cylinder 34, whereby the lower run of the band saw blade will pass between the intermediate plate 14 and the form plate 12, cf FIG. 1, whereby a portion of the material corresponding to the shape and depth of the cavity of form 18 will be severed from the item 40.

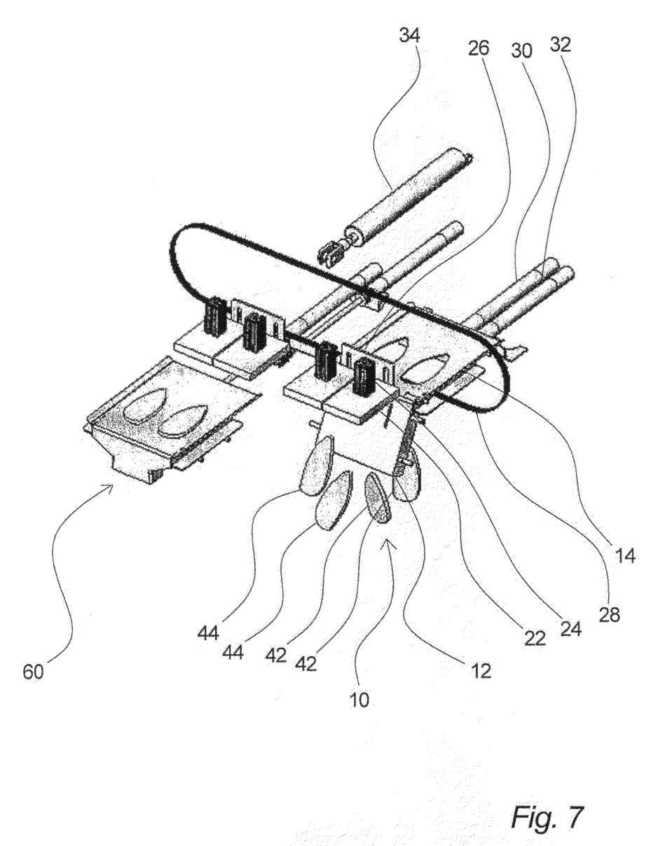

When the band saw 28 has passed through the material 40, as shown in FIG. 7, the pressure plates 22 are lifted and the form plate 12 and the intermediate plate 14 will be moved further backwards by means of the cylinder 32. Simultaneously, the band saw 28 will be moved backwards by means of the cylinder 34. When the form plate 12 and the intermediate plate 14 are moved backwards, the remaining portions or the excess portions 44 of the items 40 will contact the lower edge of the scraper 26 and as a consequence they will slide along the intermediate plate 14 until they fall or slide over the edge as shown. Further, only the intermediate plate 14 is guided e.g. by guiding means (not shown) placed for example lateral of the plates, to remain in an essentially horizontal position, whereas the form plate 12 at a certain position is allowed to (gradually) pivot in relation to the intermediate plate 14, e.g. guided by said guiding means. When the form plate 12 swings downwards, the portions 42, i.e. the primary portions, are released as shown. Possibly, means for releasing the primary portions or means for assisting the release of these portions may be provided.

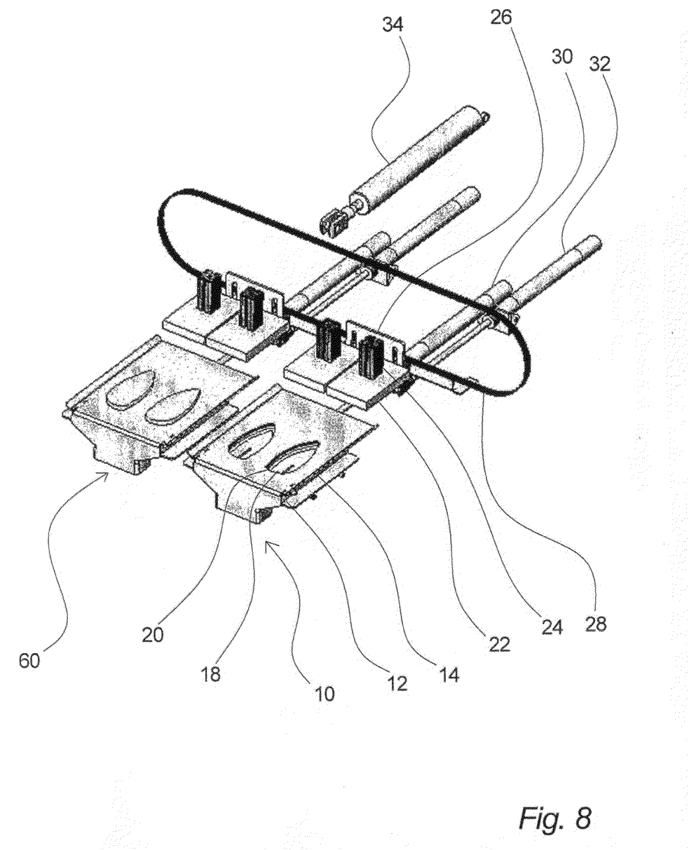

In the next step, as shown in FIG. 8, the form plate 12 and the intermediate plate 14 are pushed forward again by means of the cylinders 30 and 32, during which movement the form plate 12 pivots back to an essentially horizontal position, e.g. guided by said guiding means. When the plates 12 and 14 reach the end position, i.e. the loading position, the forms are ready to be loaded with items to be cut, e.g. meat or fish items etc.

When operating the apparatus, which as shown in FIGS. 2-8 may comprise two operative parts 10 and 60, an operator may place the items 40 to be cut. In a manual mode the apparatus may be configured to wait in the loading position for a signal before proceeding with the operation. Such a signal may for example stem from a button activated by the operator, when he/she has placed the items on the intermediate plate 14. Instead, the apparatus may be configured for operating in an automatic mode, wherein the loading time may be preset within certain limits, corresponding to the time needed for the operator to place the meat, e.g. meat items such as fish fillets, pieces of poultry or meat items of other animals, on the apparatus, whereby the apparatus will perform in an automatic manner.

Further, it is noted that the two operative parts 10 and 60 may operate as explained above, i.e. in a “push-pull” manner, where one of the parts is being loaded, while the other performs a cutting operation. This has the advantage that the operator can attend the two operative parts alternatively.

Alternatively, the two operative parts may operate in parallel, where both are loaded in the same step, both are performing the cutting simultaneously, etc.

Further, it is understood that even though it has been illustrated that the form plates comprise two forms or cavities, only a single form or cavity can be used, and more than two forms or cavities can be used for a single form plate.

Even further, it is noted that an apparatus may comprise only one operative part, e.g. the part 10.

The form plate 12 and the intermediate plate 14 may be configured especially for handling meat items such as the so-called “butterflies”, which consist of two halves which can be separated. When the plates 12 and 14 are configured with a small part between the two openings 20, a butterfly can be placed on the intermediate plate 14 with each half part in each of the openings 20. When the butterfly is processed, the two halves will be separated by the band saw 28.

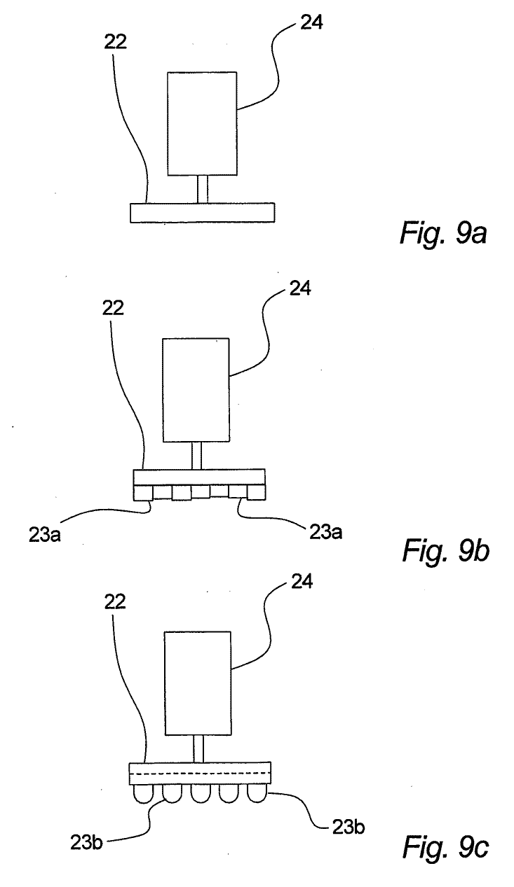

The pressure plate 22 is in FIGS. 2-8 shown as being a uniform plate corresponding to each item 40. However, it will be understood that one plate may be used for both items in a double-form, but since the items can differ in size, it is preferred to use a pressure plate for each item. Other embodiments of the pressure plate will be explained with reference to FIGS. 9a-9c, of which FIG. 9a shows a pressure plate 22 as previously described with a plain plate 22. Further, the items, e.g. the meat pieces may vary in e.g. thickness, thus causing the pressure from the pressure plate to be distributed unevenly over the meat portion and thus also leading to a less than optimal fit to the form 18. In order to alleviate such problems, the pressure plate 22 may be configured with a plurality of independently movable plates, plungers 23a or fingers 23b that each may transfer a force to the item. Such plates, plungers or fingers may for example each be springloaded or they may be pneumatically activated or arranged as illustrated in FIG. 9b. According to a further embodiment, the pressure plate may be designed as an inflated/inflatable element, for example having a plurality of fingers 23b downwards as shown in FIG. 9c, whereby the individual fingers 23b will provide a pressure downwards that is evenly distributed. Other manners of designing the pressure plate in order to achieve an optimal distribution of the pressure on the item are possible, which will be apparent to the skilled person.

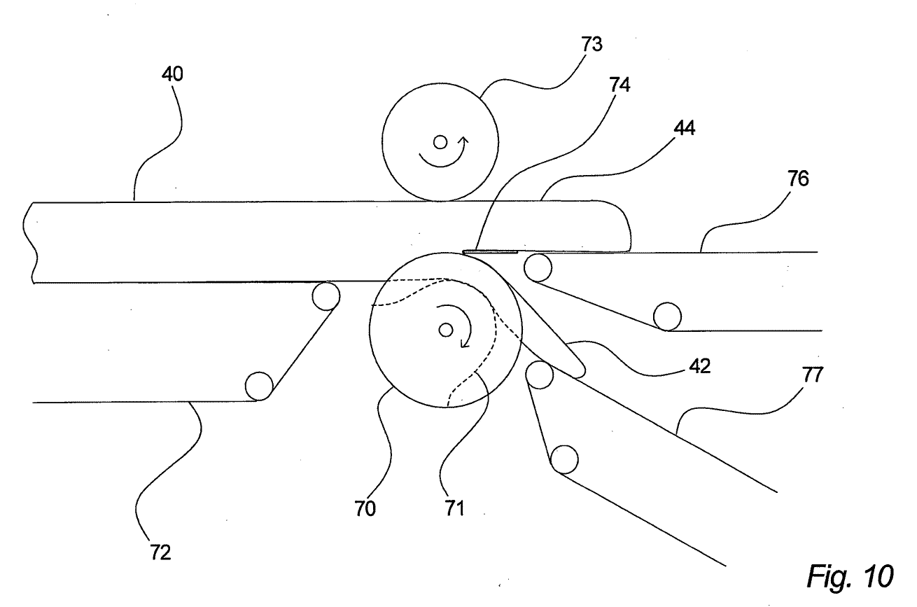

An embodiment in accordance with a further aspect of the invention is shown in FIG. 10, which shows a cutting apparatus comprising a roller 70 having a cavity 71. The cavity 71 has dimensions and a shape corresponding to the desired size/weight and form of the primary portions. Further, the apparatus comprises a roller 73 without a cavity, which roller 73 is placed in such a manner that it can urge the material, e.g. the meat, fish etc. to be cut into the cavity 71. The apparatus is equipped with e.g. a feeding conveyor 72 for forwarding the material 40 to the cutting apparatus, where it is pressed into the cavity 71 by the rotating rollers 70 and 73. A cutting device 74 such as e.g. a knife or saw, performs a cut in the vicinity of the surface of the roller 70, thus resulting in primary cuts or portions 42 being made. These primary portions are transported further on by means of e.g. a take-away conveyor 77. The excess portion 44 of the material can be transported further on by means of a take-away conveyor 76. The excess portion 44 may possibly be processed again by the cutting apparatus, if the excess portion has a size that allows further primary portions to be made, or the excess portion may be processed in another manner, e.g. cut into strips, chopped etc. The roller 70 with the cavity 71 may be placed below the other roller 73 as shown in the figure or vice versa.

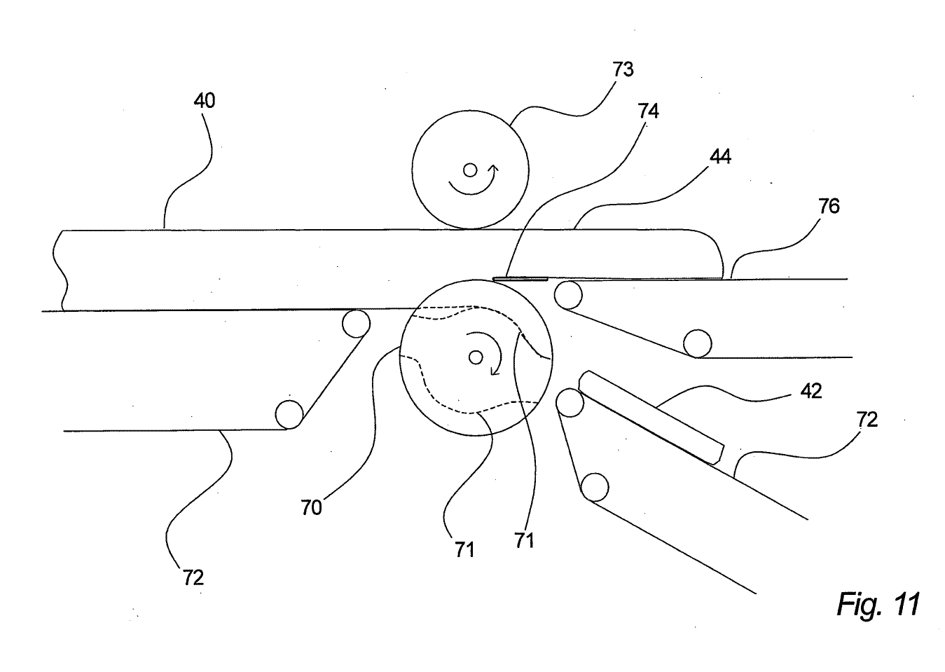

It is apparent that the roller 70 may comprise more than one cavity 71, placed in the axial direction of the roller. However, as shown in FIG. 11, two or more cavities 71 may be placed in the roller in the circumferential direction, thus causing two or more primary portions to be produced for each revolution of the roller 70. It is apparent that this embodiment may also comprise a number of cavities placed alongside each other in the axial direction of the roller 70.

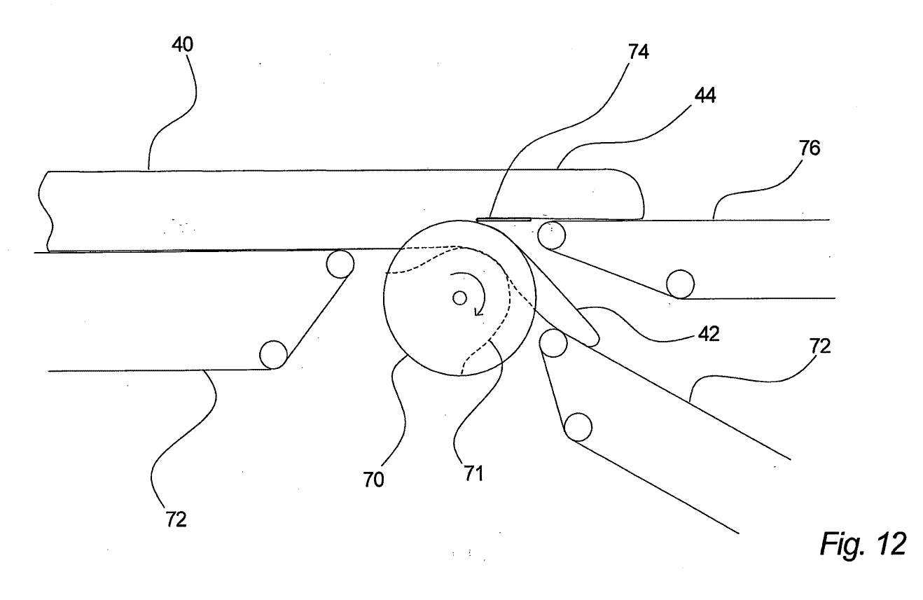

A further embodiment of such a cutting apparatus is shown in FIG. 12, where the material 40 is urged into the cavity 71 of the roller 70 by means of under-pressure instead of pressure supplied with a roller. The apparatus comprises a vacuum source, which is connected to the cavity 71, e.g. holes places in the surface of the cavity, whereby the e.g. meat is effectively sucked into the cavity. The cutting apparatus shown in FIG. 12 may otherwise be designed as the cutting apparatus shown in FIG. 10 or 11.

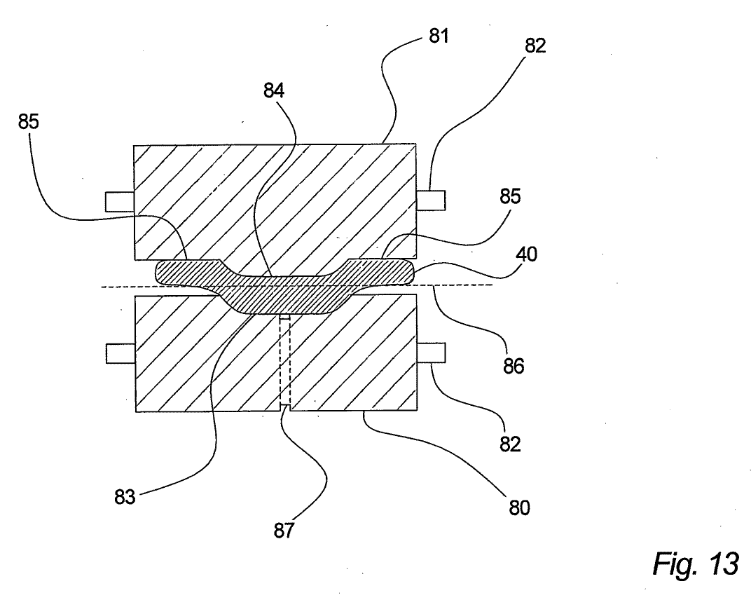

A still further embodiment of a cutting apparatus as described in connection with FIGS. 10-12 is shown in FIG. 13, where two rollers 80 and 81 are shown in a sectional view along the axis of the rollers as represented by the axles 82 of the rollers. One of the rollers 80 has a cavity 83 for defining the size and shape of a desired primary portion of e.g. a meat portion 40 as described above. In order to assist in urging the material, e.g. the meat 40 into the cavity 83, the other roller 81 is provided with an elevation or rise 84, which may correspond to the shape and/or size of the cavity 83. In order to further assist in providing a well defined primary portion, as illustrated by the cutting line 86, the roller 85 may be provided with means for creating an adherence of the edge part of the material 40 to the roller 82. Such means may for example be vacuum sources 85, e.g. holes in the roller 81 connected to a vacuum source. Thereby, a cutting device such as e.g. a band saw or knife or a reciprocating knife can perform a well-defined cut as shown by the cutting line 86. Further, this embodiment illustrates a further feature that may be advantageous in connection with such cutting apparatus. As shown, a track or groove 87 may be provided in the roller 80, and a tool (not shown) such as e.g. a finger placed with its tip in the groove 87 may be designed for lifting the e.g. meat portion using this track or groove 87. It will be understood that these rollers 80 and 81 also may be interchanged, e.g. the roller with the cavity 83 may be placed above the other roller, e.g. the roller with the rise 84. Further, it will be understood that more than one cavity and rise, respectively, may be provided for each roller, corresponding to what has been explained for the other embodiments.

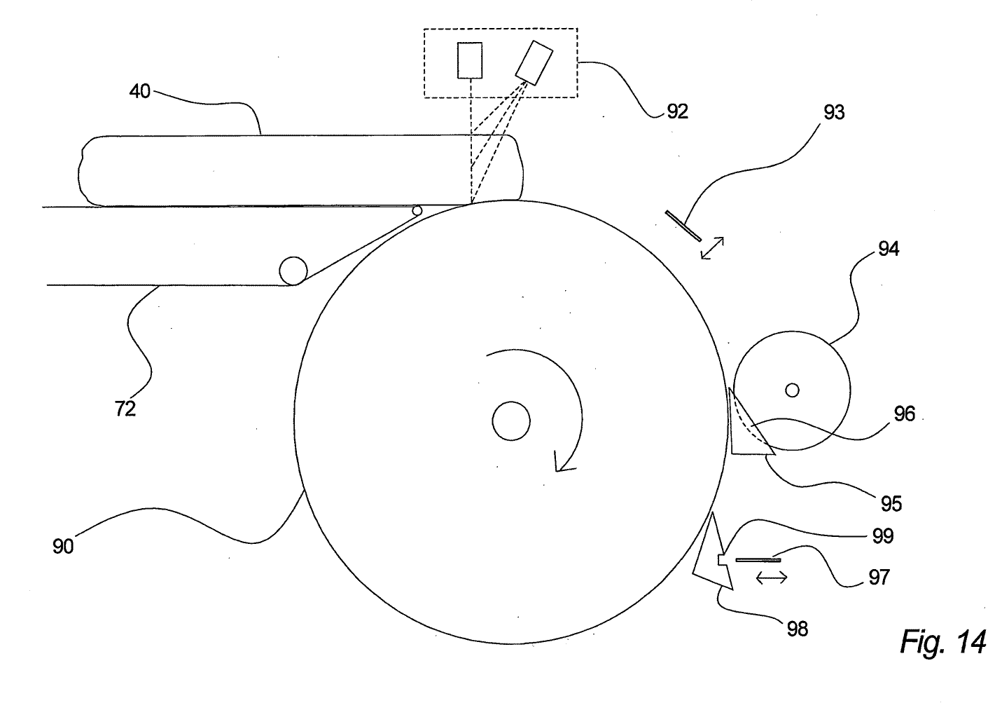

Finally, a still further embodiment of a cutting apparatus in accordance with a further aspect of the invention is shown in FIG. 14, where a roller 90 is used for supporting the material 40, e.g. a piece of meat, while it is being cut into a desired shape and size. The roller 90 is not provided with cavities and/or rises/elevations but has an e.g. circular cylindrical surface. The material 40 is forwarded to the roller by means of e.g. a forwarding conveyor 72, and the material adheres to the surface of the roller by means of e.g. suction or freezing. For example, the surface may be provided with holes connected to a vacuum source, whereby the material is sucked towards the surface, or the surface may be in connection with means for providing the surface with a sub-zero temperature, whereby the e.g. meat will stick to the surface when it has been brought in contact with the surface. Examples of prior art techniques using freezing drums for transporting of food material are described in U.S. Pat. No. 5,507,690, U.S. Pat. No. 5,810,652 and WO 9907228. However, these prior art techniques do not relate to the same matter as the present invention. Further, vacuum rollers have also been described in the prior art, for example in U.S. Pat. No. 5,391,386 and U.S. Pat. No. 5,149,554, which however relate to the transport of food product slices.

When the piece 40 of e.g. meat enters the roller 90, it is measured and/or scanned by means of a vision system 92, and by means of a control system (not shown) a cutting operation for achieving a desired/predetermined primary portion is determined. The material is cut by means of e.g. a band knife or saw 93, which can be adjusted in relation to the surface of the roller in order to achieve the desired thickness of the primary portion. Further, the shape of the primary portion can be cut by means of a rotating knife or saw 94, which may be controlled to transverse along the axis of the roller and/or may be controlled to turn in order to achieve a desired shape, e.g. a curved side. One or two of these knifes 94 may be provided. As shown, a lifting tool 95 may be provided for lifting the e.g. piece of meat at least marginally from the surface of the roller 90 in order to avoid contact between the blade 94 and the surface of the roller 90. The tool 95 may as shown be wedge-shaped and may comprise a groove 96 for accommodating the edge of the blade 94. Still further, a knife, e.g. a reciprocating knife 97 may be provided for cutting the primary portion to the desired length. This knife or blade 97 may also be combined with an e.g. wedge-shaped lifting tool 98 for lifting the e.g. piece of meat from the surface of the roller when a cut is made, and for the cutting purpose the lifting tool 98 may be provided with a groove 99.

Further, it is noted that conveyor bands may be used for supporting and transporting the material to be cut, e.g. during the cutting process. Such conveyor bands may for example comprise holes for supplying a vacuum for withholding the material. Especially, homogenous conveyor bands may be used for hygienic reasons, e.g. since such bands do not comprise voids, wherein bacteria may grow. An example of such a conveyor band is produced and marketed by VOLTA® Belting Technology Ltd.

Still further, it is noted that a turntable may also be used as support means and that such a turntable may also be provided with cavities and/or elevations as described above in connection with the examples. Also, force applying means as previously described may also be utilized in connection with such a turntable.

It will be understood that the invention is not limited to the examples described above and shown in the drawings but may be modified and combined in numerous manners, used in a wide variety of applications and manufactured in materials commonly used within the field. Thus, it will be understood that the device according to the invention may be designed in a multitude of varieties within the scope of the invention as specified in the claims.

1: Apparatus for cutting of material, said material including a piece of meat, poultry or fish, said apparatus comprising:
support means for said material, said support means comprising a cavity; and
cutting means for cutting said piece of material to a predetermined thickness and shape,
said apparatus further being configured for cutting said piece of material as regards thickness and shape during a relative displacement between the support means and the cutting means, wherein
said support means comprises a form plate and an intermediate plate, said form plate comprising said cavity and said intermediate plate correspondingly comprising an opening, wherein
said cutting means is configured for passing between the intermediate plate and the form plate, and wherein
the apparatus further comprises means for applying force to said material towards said cavity urging the material towards the shape of the cavity, and wherein
said means for applying force to said material towards said cavity comprises an actuator.

2: Apparatus according to claim 1, wherein said support means and said cutting means are configured to be relatively displaceable in a reciprocating manner, and wherein means are provided for relatively displacing said support means and said cutting means.

3. (canceled)

4: Apparatus according to claim 1, wherein said support means comprises at least a support part that is arranged to be pivotal.

5: Apparatus according to claim 4, wherein said support part that is arranged to be pivotal comprises said form plate that is pivotally connected to said intermediate plate.

6: Apparatus according to claim 1, wherein said support means are configured to reciprocate between a loading position and an off-loading position.

7: Apparatus according to claim 6, wherein said cutting means are adapted for performing a cutting operation while being moved in relation to a said support means being located in a cutting position.

8: Apparatus according to claim 1, wherein said support means comprises at least two cavities corresponding to pieces of material to be cut.

9: Apparatus according to claim 1, wherein said apparatus comprises at least two operative parts, each comprising support means and means for applying force to said material towards said cavity.

10: Apparatus according to claim 9, wherein said operative parts are controlled in such a manner that said operative parts are in a loading position alternatively.

11: Apparatus according to claim 9, wherein said operative parts are controlled in such a manner that said operative parts are in a loading position essentially simultaneously.

12: Apparatus according to claim 1, wherein said means for applying force to said material towards said cavity comprises a pressure plate.

13: Apparatus according to claim 1, wherein said means for applying force to said material towards said cavity comprises a pressure means comprising a plurality of independently movable fingers or plungers.

14: Apparatus according to claim 1, wherein said cutting means comprises a band saw or knife.

15: Apparatus according to claim 1, wherein said support means comprises a roller or drum.

16: Apparatus according to claim 1, wherein said support means comprises a turntable.

17: Apparatus according to claim 1, wherein said support means comprises a conveyor band.

18: Apparatus according to claim 15, wherein said support means comprises an elevation or a cavity.

19: Apparatus according to claim 1, wherein means for applying force to said material comprises a roller or drum.

20: Apparatus according to claim 19, wherein said roller or drum comprises an elevation or a cavity.

21: Apparatus according to claim 1, wherein said apparatus comprises means for retaining said material to the support means, said means for retaining said material comprising vacuum means and/or freezing means.

22: Apparatus according to claim 1, wherein said cutting means comprises reciprocating and/or rotating cutting means that may be controllable as regards the distance and position in relation to said support means.

23: Apparatus according to claim 1, wherein said apparatus comprises scanning, measuring and/or detection means.

24: Apparatus according to claim 1, wherein said apparatus comprises means for lifting, releasing and/or assisting in releasing cut portions from said support means, in the form of scraper means and/or finger means which may be configured for cooperating with a notch or a groove in said support means.

25: Apparatus according to claim 16, wherein said support means comprises an elevation or a cavity.

26: Apparatus according to claim 17, wherein said support means comprises an elevation or a cavity.
